(19) United States
(12) Patent Application Publication
(10) Pub. No.: US 2004/0113891 A1
(43) Pub. Date: Jun. 17, 2004

(54) Method for transmitting and receiving data of wireless keyboard

(76) Inventor: Jee Sung Lee, Suwon (KR)

Correspondence Address: LOWE HAUPTMAN GOPSTEIN GILMAN & BERNER, LLP, Suite 310, 1700 Diagonal Road, Alexandria, VA, 22314, US

(21) Appl. No.: 10/600,367

(22) Filed: Jun. 23, 2003

(30) Foreign Application Priority Data
Dec. 12, 2002 (KR) 2002-79065
May 23, 2003 (KR) 2003-32797

(51) Int. Cl. G09G 5/00

(52) U.S. Cl. 345/169

(57) ABSTRACT

A method for transmitting and receiving data of a wireless keyboard. In the method for transmitting keyboard data between a computer and a wireless keyboard having a plurality of general keys and a number of function keys, the keyboard data is generated in response to a key press or press release. The keyboard data includes fixed data containing a leader indicating a transmission of the keyboard data, variable data, and inverted variable data. The variable data includes a 1-bit special bit indicating whether a function key has been pressed, a make/brake bit indicating whether a key has been pressed, and a scan code corresponding to a pressed or press-released key. After the keyboard data is generated, the generated keyboard data is transmitted through an air interface. A data error can be confirmed without assigning a checksum bit field to the keyboard data. An amount of battery power consumption can be minimized irrespective of a demodulation method. Another function key can be added to the wireless keyboard without increasing a size of data.

### BACKGROUND OF THE INVENTION

1. Field of the Invention

The present invention relates to a method for transmitting and receiving data of a wireless keyboard, and more particularly to a method for transmitting and receiving data of a wireless keyboard, which can provide variable data varying with an input key, inverted variable data, and fixed data on the basis of a new communication protocol, correctly confirm a data error without assigning a checksum bit field to the keyboard data, minimize an amount of battery power consumption irrespective of a demodulation method, and add another function key to the wireless keyboard without increasing a size of data.

2. Description of the Related Art

In a conventional communication protocol of a wireless keyboard based on an infrared (IR) or radio frequency (RF) signal, a 4-pulse position modulator (4PPM), a pulse width modulator (PWM) and a simple pulse modulator are widely used. The PWM as well as the simple pulse modulator produces a logic “0” or “1” on the basis of a pulse width. The pulse width varies with a data code. Where the pulse width expressed as the logic “1” or “0” varies, a size of data can be increased. Thus, an amount of electric power consumption is increased. There is a drawback in that an amount of battery power consumption cannot be minimized.

To address this drawback, the 4PPM capable of producing the logic “1” or “0” on the basis of a pulse generation point can be used. The communication protocol for use in the 4PPM uses a plurality of special bits corresponding to respective function keys so that a transmission error associated with a function key arranged on a keyboard can be prevented. So, the special bits are transmitted at a time of transmitting keyboard data. Even though the transmission error occurs while the keyboard data is transmitted, the transmission error can be compensated for since the press or press-release information associated with the function key is transmitted along with data of the next pressed key at the same time. As an example, a wireless-keyboard data transmission method using the conventional 4PPM will be described.

FIG. 1 is a schematic block diagram illustrating a conventional wireless keyboard. Referring to FIG. 1, the conventional wireless key 1 includes a microprocessor 11, a key matrix 13 and a transmission unit 15. The microprocessor 11 applies a scanning signal to the key matrix 13. The microprocessor 11 searches for a pressed or press-released key from among keys of the key matrix 13 and transmits keyboard data containing a scan code associated with a corresponding key to a personal computer 3 through the transmission unit 15.

FIG. 2 is a view illustrating a format of data according to the keyboard data transmission method using the communication protocol for the 4PPM associated with the conventional wireless keyboard. Referring to FIG. 2, a channel ID data field is assigned to keyboard data where the conventional personal computer 3 is coupled to a plurality of wireless keyboards 1. Further, where additional window keys are provided in a wireless keyboard 1, a window key flag field for the window keys is assigned to the keyboard data. That is, as shown in FIG. 2, the keyboard data of a conventional system includes a total of 32 bits, i.e., a total of 4 bytes (B1, B2, B3 and B4). Five bits (Bit7, Bit6, Bit5, Bit4 and Bit3) within the first byte (B1) of the keyboard data corresponds to an ID of the wireless keyboard 1.

A mouse or a remote controller can be used as an input unit for inputting the ID information. The ID information is used for identifying keyboard data from data transmitted by an IR or RF module. In this case, a leader indicating the transmission of keyboard data can be assigned to the eighth bit (Bit7). Data items corresponding to window keys are assigned to three bits (Bit2, Bit1 and Bit0) within the first byte (B1). State information items of left and right window keys are assigned as the first and second bits (Bit0 and Bit1) of the first byte (B1). The fourth bit (Bit3) is a reserved bit capable of being assigned to another window key.

Next, the second byte (B2) is data indicating that a function key has been pressed. As shown in FIG. 2, the eighth bit (Bit7) of the second byte (B2) is assigned for make and brake flags associated with function keys. The first to seventh bits (Bit0-Bit6) are assigned as flag bits of the respective function keys.

Key codes corresponding to scan codes assigned to respective keys are assigned to the third byte (B3). Here, the third byte (B3) includes make and brake codes of a corresponding key.

A channel ID is assigned to the fifth to eighth bits (Bit4-Bit7) of the fourth byte (B4). Checksum information is assigned to the first to fourth bits (Bit0-Bit3) so that a transmission error of the keyboard data can be checked. Here, the channel ID is channel information for identifying a corresponding wireless keyboard where a plurality of wireless keyboards are used.

When combining function keys and general keys, most users use a combination of one function key and one general key more frequently than a combination of two function keys and one general key or a combination of three function keys and one general key.

However, a conventional method for assigning special bits to the respective function keys must assign a function-key data field having the number of bits being the same as the number of function keys. There is a drawback in that a size of the data field is increased as the number of function keys is increased. Further, there is another drawback in that the increased size of data increases an amount of electric power consumption. Furthermore, there is another drawback in that an additional checksum code used for checking the transmission error must be assigned and hence the size of data is increased.

Since the size of keyboard data is increased when another function key is added to the wireless keyboard, its efficiency is degraded. There is yet another drawback in that a size of the data field must be increased where other function keys are continuously added to the wireless keyboard.

### SUMMARY OF THE INVENTION

Therefore, it is one object of the present invention to provide a method for transmitting and receiving data of a wireless keyboard, which can provide variable data varying with an input key, inverted variable data, and fixed data on the basis of a new communication protocol.

It is another object of the present invention to provide a method for transmitting and receiving data of a wireless keyboard, which can correctly confirm a data error without assigning a checksum bit field to the keyboard data.

It is yet another object of the present invention to provide a method for transmitting and receiving data of a wireless keyboard, which can minimize an amount of battery power consumption irrespective of a demodulation method, and add another function key to the wireless keyboard without increasing a size of data.

In accordance with the first aspect of the present invention, the above and other objects can be accomplished by the provision of a method for transmitting keyboard data between a computer and a wireless keyboard having a plurality of general keys and a number of function keys, comprising the steps of: (a) generating the keyboard data in response to a key press or press release, the keyboard data including fixed data containing a leader indicating a transmission of the keyboard data, variable data, and inverted variable data, the variable data including a 1-bit special bit indicating whether a function key has been pressed, a make/brake bit indicating whether a key has been pressed, and a scan code corresponding to a pressed or press-released key; and (b) transmitting the generated keyboard data through an air interface.

In accordance with the second aspect of the present invention, there is provided a method for receiving keyboard data between a computer and a wireless keyboard having a plurality of general keys and a number of function keys, comprising the steps of: (a) receiving and processing the keyboard data, the keyboard data including fixed data containing a leader indicating a transmission of the keyboard data, variable data, and inverted variable data, the variable data including a 1-bit special bit indicating whether a function key has been pressed, a make/brake bit indicating whether a key has been pressed, and a scan code corresponding to a pressed or press-released key; and (b) performing an operation corresponding to the received and processed keyboard data.

In accordance with the third aspect of the present invention, there is provided a combination of the first and second aspects.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram illustrating a conventional wireless keyboard;

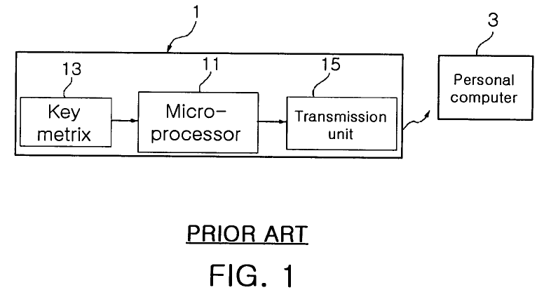

FIG. 2 is a view illustrating a format of data according to a method for transmitting data of the conventional keyboard;

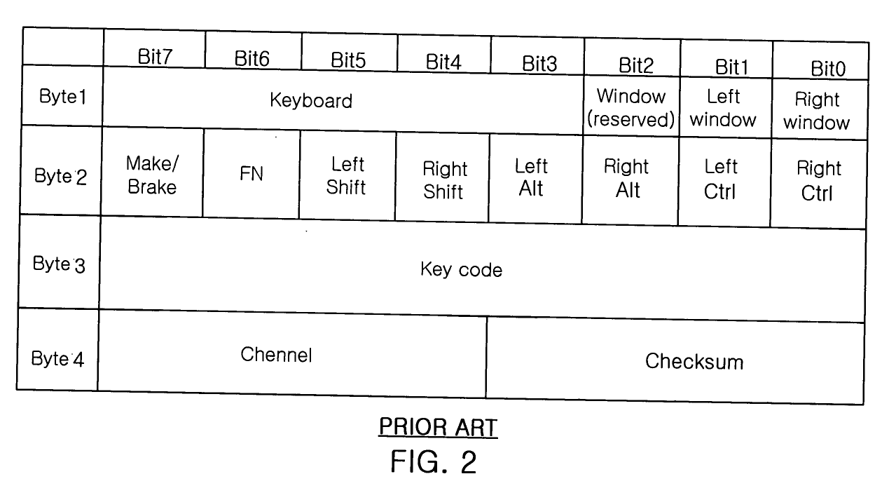

FIG. 3 is a view illustrating the configuration of a wireless-keyboard data transmission device for implementing the present invention;

FIG. 4 is a flowchart illustrating a wireless-keyboard data transmission method in accordance with the present invention;

FIG. 5 is a view illustrating a format of wireless keyboard data in accordance with the present invention;

FIG. 6 is a view illustrating a format of a wireless keyboard data packet in accordance with the present invention;

FIG. 7 is a view illustrating the configuration of a wireless-keyboard data reception device for implementing the present invention; and

FIG. 8 is a flowchart illustrating a wireless-keyboard data reception method in accordance with the present invention.

### DESCRIPTION OF THE PREFERRED EMBODIMENTS

A method for transmitting and receiving data of a wireless keyboard in accordance with preferred embodiments of the present invention will be described in detail with reference to the annexed drawings.

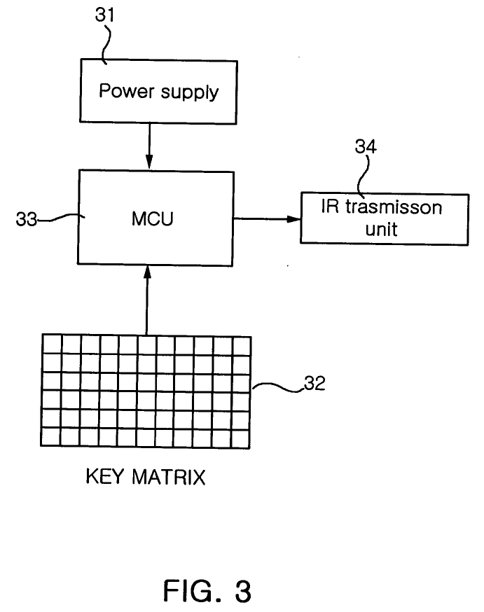

FIG. 3 is a view illustrating the configuration of a wireless-keyboard data transmission device for implementing the present invention. Referring to FIG. 3, the wireless-keyboard data transmission device for implementing the present invention includes a power supply 31 for supplying necessary electric power to a wireless keyboard; a key matrix 32 for receiving an input key according to a key press or press release; a micro controller unit (MCU) 33 for recognizing the key press or press release and controlling an operation of transmitting corresponding keyboard data through an air interface; and an infrared (IR) transmission unit 34 for converting data into an IR signal being a wireless signal under the control of the MCU 33 and transmitting the wireless signal through the air interface. Under the control of the MCU 33, the following wireless-keyboard data transmission method in accordance with the present invention is performed.

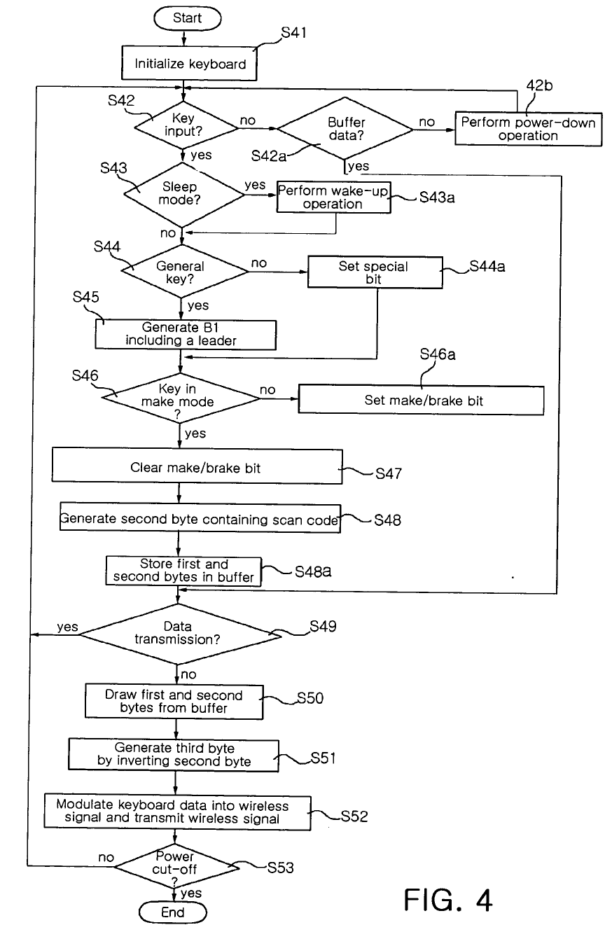

FIG. 4 is a flowchart illustrating the wireless-keyboard data transmission method in accordance with the present invention. Referring to FIG. 4, there is shown the wireless-keyboard data transmission method for transmitting keyboard data from the wireless-keyboard data transmission device to a wireless-keyboard data reception device. The wireless-keyboard data transmission method will be described in detail.

In the method for transmitting the keyboard data between a computer and a wireless keyboard having a plurality of general keys and a number of function keys in accordance with the present invention, the keyboard data is generated in response to a key press or press release. The keyboard data includes fixed data containing a leader indicating a transmission of the keyboard data, variable data, and inverted variable data. The variable data includes a 1-bit special bit indicating whether a function key has been pressed, a make/brake bit indicating whether a key has been pressed, and a scan code corresponding to a pressed or press-released key. After the keyboard data is generated, the generated keyboard data is transmitted through the air interface.

As described above, the fixed data includes the leader indicating the transmission of the keyboard data. The variable data includes the special bit indicating whether the function key has been pressed, the make/brake bit indicating whether the key has been pressed, and the scan code corresponding to the pressed or press-released key. The inverted variable data includes an inverted special bit, an inverted make/brake bit and an inverted scan code. The fixed data can include channel information according to a product or use environment as well as the leader indicating the transmission of the keyboard data.

The first byte contained in the keyboard data to be received includes the leader, the special bit and the inverted special bit. The second byte includes the make/brake bit and the scan code. The third byte includes the inverted make/brake bit and the inverted scan code produced by inverting the make/brake bit and scan code of the second byte.

A method for assigning the special bit and inverted special bit in accordance with the present invention is different from the conventional method for assigning the special bit and inverted special bit. In other words, the conventional method assigns the special bit and inverted special bit to each function key. However, the method in accordance with the present invention fixes each of the special bit and inverted special bit to one bit irrespective of the function keys. Thus, even though another function key is added to the wireless keyboard, the number of special bits is not increased. Furthermore, the size of keyboard data is not increased.

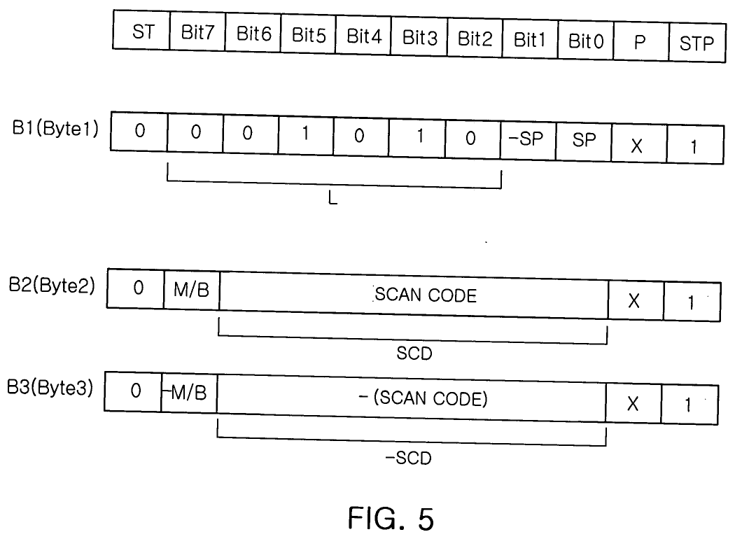

Referring to FIGS. 4 and 5, a keyboard data generation procedure generates the first byte (B1) including a leader (L) of fixed bits, a special bit (SP) indicating state information of a function key, and an inverted special bit (-SP) in response to a key press or press release at steps S41 to S45.

As described above, the first byte (Bi) includes the inverted special bit (-SP). The inverted special bit (-SP) is used for correctly checking a transmission error associated with the special bit (SP). It is preferable that the special bit or inverted special bit is assigned as one bit. The special bit (SP) is set to “1” if the function key is in a make mode. Further, the special bit (SP) is set to “0” if the function key is in a brake mode.

Then, a second byte generation procedure generates the make/brake bit (M/B) indicating whether the key has been pressed, and the scan code (SCD) corresponding to the pressed or press-released key, and generates the second byte (B2) including the make/brake bit (M/B) and scan code (SCD) at steps S46 to S48. At this time, the make/brake bit (M/B) is set to “1” if the key has been pressed. Otherwise, the make/brake bit (M/B) is set to “0” or cleared if the pressed key has been released. Thus, the second byte (B2) including the make/brake bit (M/B) of “1” or “0” and the scan code (SCD) is generated. The first and second bytes (B1 and B2) are stored in a buffer before they are transmitted.

Then, a third byte generation procedure generates the third byte (B3) including inverted data produced by inverting the make/brake bit (M/B) and the scan code (SCD) included in the second byte (B2) at steps S49, S50 and S51. That is, it is determined whether the transmission of the keyboard data is ongoing at the above step S49. If the transmission of the keyboard data is ongoing, the first byte generation procedure is performed at the above steps S42 to S45. Otherwise, there is generated the third byte (B3) including the inverted data produced by inverting the make/brake bit (M/B) and the scan code (SCD) which are included in the second byte (B2) stored in the buffer at the above step S50. Then, the third byte (B3) including an inverted make/brake bit (-M/B) and an inverted scan code (-SCD) being the inverted data is generated at the above step S51.

Then, in a procedure of transmitting the keyboard data at steps S52 and S53, the keyboard data including the generated first, second and third bytes (B1, B2 and B3) is converted into a wireless signal, and the wireless signal is transmitted. In this procedure, a parity bit is added to each byte of the keyboard data to be transmitted. A start bit (ST) and stop bit (STP) are added to a head and tail of each byte contained in the keyboard data.

In the procedure of converting the keyboard data into the wireless signal and transmitting the wireless signal, the keyboard data contained in the generated first to third bytes is converted into the wireless signal in units of packets so that the wireless signal can transmitted.

FIG. 5 is a view illustrating a format of the wireless keyboard data in accordance with the present invention. The keyboard data includes the first byte (B1), the second byte (B2) and the third byte (B3). The respective bytes can commonly include the start bit (ST), the parity bit (P) and the stop bit (STP). The first byte (B1) includes the leader (L) indicating the transmission of the keyboard data, the special bit (SP) indicating whether the function key has been pressed, and the inverted special bit (-SP). Further, the second byte (B2) includes the make/brake bit (M/B) indicating whether the key has been pressed, and the scan code (SCD) corresponding to the pressed or press-released key. Furthermore, the third byte (B3) includes complementary values for the make/brake bit (M/B) and scan code (SCD), i.e., the inverted make/brake bit (-M/B) and inverted scan code (-SCD).

As described above, the complementary values for the make/brake bit (M/B) and scan code (SCD) contained in the second byte in accordance with the keyboard data of the present invention are the same as the inverted make/brake (-M/B) and inverted scan code (-SCD) contained in the third byte (B3). Thus, a transmission error of the keyboard data can be correctly checked using the second and third bytes without assigning an additional checksum code to the keyboard data.

The keyboard data, consisting of the first, second and third bytes (B1, B2 and B3), is converted into the wireless signal and the wireless signal can be transmitted through an air interface.

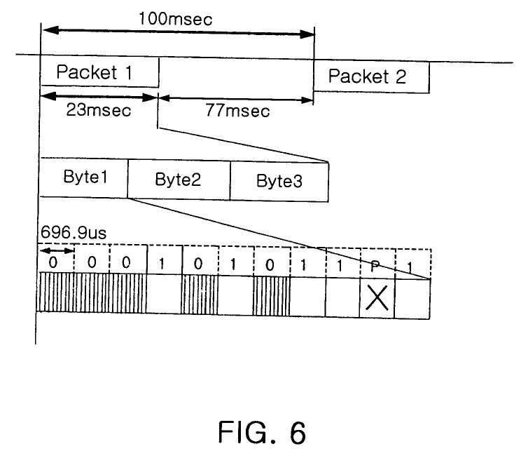

In accordance with the present invention, the size of a packet of the keyboard data can be minimized. The format of the packet of the keyboard data is shown in FIG. 6.

FIG. 6 is a view illustrating the format of the wireless keyboard data packet in accordance with the present invention. Referring to FIG. 6, the size of the keyboard data is based on approximately 23 ms, and a time interval between packets is set to approximately 77 ms. Further, each byte within each packet includes 11 bits. The size of each bit is based on approximately 696.9 μs.

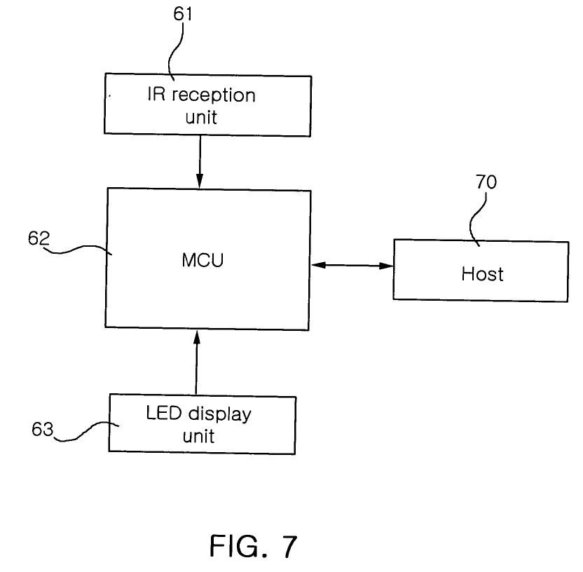

FIG. 7 is a view illustrating the configuration of a wireless-keyboard data reception device for implementing the present invention. Referring to FIG. 7, the wireless-keyboard data reception device for implementing the present invention includes an infrared (IR) reception unit 61 for receiving keyboard data from the above-described wireless-keyboard data transmission device through an air interface; a micro controller unit (MCU) 62 for controlling an operation corresponding to the keyboard data received from the IR reception unit 61; and a light emitting diode (LED) display unit 63 for displaying information indicating a transmission state of the keyboard data under the control of the MCU 62. Under the control of the MCU 62, the wireless keyboard data reception procedure is performed in accordance with the present invention.

Next, the wireless-keyboard data reception method in accordance with the present invention will be described.

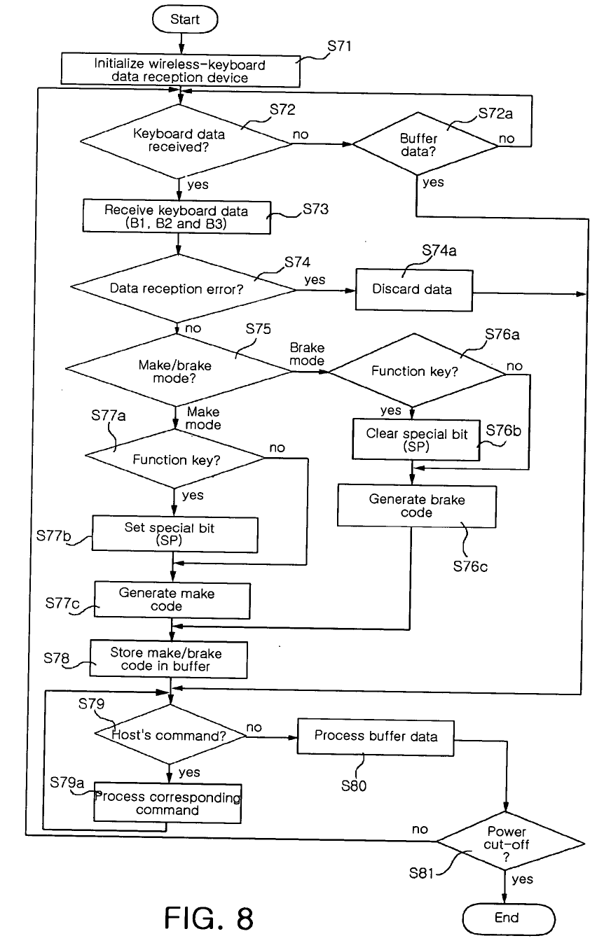

FIG. 8 is a flowchart illustrating the wireless-keyboard data reception method in accordance with the present invention. The operation of enabling the wireless-keyboard data reception device to receive the keyboard data from the wireless-keyboard data transmission device through an air interface will be described in detail with reference to FIG. 8.

In the method for receiving keyboard data between a computer and a wireless keyboard having a plurality of general keys and a number of function keys in accordance with the present invention, the above-described keyboard data reception device receives and processes the keyboard data. The keyboard data includes fixed data containing a leader indicating a transmission of the keyboard data, variable data, and inverted variable data. The variable data includes a 1-bit special bit indicating whether a function key has been pressed, a make/brake bit indicating whether a key has been pressed, and a scan code corresponding to a pressed or press-released key. After the keyboard data is received and processed, an operation corresponding to the received and processed keyboard data is performed.

As described above, the fixed data contained in the keyboard data includes the leader indicating the transmission of the keyboard data. The variable data includes the special bit indicating whether the function key has been pressed, the make/brake bit indicating whether the key has been pressed, and the scan code corresponding to the pressed or press-released key. The inverted variable data includes an inverted special bit, an inverted make/brake bit and an inverted scan code. In particular, the special bit and inverted special bit are assigned as one bit, respectively.

The keyboard data includes the first, second and third bytes. The first byte includes the leader, the special bit and an inverted special bit. The second byte includes the make/brake bit and scan code. The third byte includes the inverted make/brake bit and scan code.. Each byte of the keyboard data includes a parity bit, a start bit added to a head of each byte, and a stop bit added to a tail of each byte.

First, in a procedure of receiving the keyboard data at steps S71 to S73, the MCU 62 receives the keyboard data including the first to third bytes (B1, B2 and B3) through the IR reception unit 61 of the wireless-keyboard data reception device. That is, a received IR signal being a wireless signal is recovered to original keyboard data. Each of the first to third bytes contained in the keyboard data can be recognized by a start bit (ST) and a stop bit (STP). It is determined whether the received wireless signal corresponds to the keyboard data on the basis of a leader contained in the first byte (B1). If the received wireless signal corresponds to the keyboard data, the MCU 62 receives the keyboard data including the first to third bytes (B1, B2 and B3) through the IR reception unit 61.

Then, in a procedure of checking a transmission error associated with the keyboard data at step S74, the transmission error is checked on the basis of the second and third bytes (B2 and B3) contained in the keyboard data. That is, the transmission error of each byte is checked using a parity bit (P) within each byte contained in the keyboard data. Then, it is checked whether an inverted bit and code produced by inverting the make/brake bit and scan code contained in the second byte are the same as the inverted make/brake bit and scan code contained in the third byte. If the transmission error is detected in the transmission error checking procedure, the received keyboard data is ignored. Otherwise, the next step is performed.

At step S75, it is determined whether a key is in a make/brake mode on the basis of the make/brake bit (M/B) contained in the second byte of the keyboard data. If the make/brake bit (M/B) has been set to “1”, it is determined that the key is in the make mode. On the other hand, if the make/brake bit (M/B) has been set to “0” or cleared, it is determined that the key is in the brake mode.

In a procedure of generating a make code at step S77a to S77c, a determination is made as to whether the key is a function key on the basis of the special bit contained in the first byte if the key is in the make mode. If the key is a function key, the special bit is set to generate the make code. At this time, if the special bit (SP) of the first byte has been set, the key is recognized as a function key. On the other hand, if the special bit (SP) of the first byte has been cleared, the key is recognized as a general key.

In a procedure of generating a brake code at step S76a to S76c, a determination is made as to whether the key is a function key on the basis of the special bit contained in the first byte if the key is in the brake mode. If the key is not a function key, the special bit is cleared to generate the brake code. At this time, if the special bit (SP) of the first byte has been set, the key is recognized as a function key. On the other hand, if the special bit (SP) of the first byte has been cleared, the key is recognized as a general key.

In a procedure of performing a corresponding operation at step S78 to S81, an operation according to the special bit, make/brake code and scan code is performed. In other words, the make/brake code generated in the procedures of generating the make/brake code, are stored in a temporary buffer. Then, if a host's command exists, the host's command is processed. On the other hand, if no host's command exists, a corresponding operation according to the special bit, make/brake code and scan code is performed.

As apparent from the above description, the present invention provides a method for transmitting and receiving data of a wireless keyboard, which can provide variable data varying with an input key, inverted variable data, and fixed data on the basis of a new communication protocol, correctly confirm a data error without assigning a checksum bit field to the keyboard data, minimize an amount of battery power consumption irrespective of a demodulation method, and add another function key to the wireless keyboard without increasing a size of data.

In other words, the method of the present invention can minimize the amount of battery power consumption even though any modulator other than the conventional 4PPM is used. Further, even though another function key is added to the wireless keyboard, the method can constantly maintain the size of data without changing a data field according to the new communication protocol. When data is varied in the new communication protocol, inverted data associated with the variable data other than the fixed data is always assigned to the keyboard data to be transmitted, such that the amount of battery power consumption can be minimized and constantly maintained, and the size of data can be constantly maintained. Since the inverted variable data is assigned to the keyboard data, the data error can be correctly confirmed. There is a merit in that the size of data is not increased even though other function keys are added to the wireless keyboard since only one bit is assigned to each function key.

The preferred embodiments of the present invention have been disclosed for illustrative purposes. Those skilled in the art will appreciate that various modifications, additions and substitutions are possible, without departing from the scope and spirit of the invention as disclosed in the accompanying claims.

What is claimed is:

1. A method for transmitting keyboard data between a computer and a wireless keyboard having a plurality of general keys and a number of function keys, comprising the steps of:
(a) generating the keyboard data in response to a key press or press release, the keyboard data including fixed data containing a leader indicating a transmission of the keyboard data, variable data, and inverted variable data, the variable data including a 1-bit special bit indicating whether a function key has been pressed, a make/brake bit indicating whether a key has been pressed, and a scan code corresponding to a pressed or press-released key; and
(b) transmitting the generated keyboard data through an air interface.

2. The method as set forth in claim 1, wherein the step (a) comprises the steps of:
(a-1) generating a first byte including the leader of fixed bits, the special bit indicating state information of the function key, and an inverted special bit in response to the key press or press release, wherein the keyboard data includes the first byte, a second byte and a third byte;
(a-2) generating the second byte including the make/brake bit indicating whether the key has been pressed, and the scan code corresponding to the pressed or press-released key; and
(a-3) generating the third byte including an inverted make/brake bit and an inverted scan code.

3. The method as set forth in claim 2, wherein the special bit contained at the step (a-1) is set if a preset function key is in a make mode, and wherein the special bit contained at the step (a-1) is cleared if the function key is in a brake mode.

4. The method as set forth in claim 2, wherein the step (b) comprises the step of:
(b-1) adding a parity bit to each byte of the keyboard data to be transmitted and adding a start bit and stop bit to a head and tail of each byte; and
(b-2) transmitting the keyboard data through the air interface.

5. The method as set forth in claim 4, wherein the step (b) is carried out by converting the keyboard data of the first to third bytes into a wireless signal in units of packets, and transmitting the wireless signal.

6. The method as set forth in claim 5, wherein a size of each packet of the keyboard data is based on approximately 23 ms, and a time interval between packets is set to approximately 77 ms.

7. The method as set forth in claim 6, wherein each byte within each of the packets comprises 11 bits, a size of each of the bits being based on approximately 696.9 μs.

8. A method for receiving keyboard data between a computer and a wireless keyboard having a plurality of general keys and a number of function keys, comprising the steps of:
(a) receiving and processing the keyboard data, the keyboard data including fixed data containing a leader indicating a transmission of the keyboard data, variable data, and inverted variable data, the variable data including a 1-bit special bit indicating whether a function key has been pressed, a make/brake bit indicating whether a key has been pressed, and a scan code corresponding to a pressed or press-released key; and
(b) performing an operation corresponding to the received and processed keyboard data.

9. The method as set forth in claim 8, wherein the keyboard data comprises:
a first byte including the leader, the special bit and an inverted special bit;
a second byte including the make/brake bit and the scan code; and
a third byte including an inverted make/brake bit and an inverted scan code.

10. The method as set forth in claim 9, wherein each byte of the keyboard data comprises:
a parity bit;
a start bit added to a head of each byte; and
a stop bit added to a tail of each byte.

11. The method as set forth in claim 10, wherein the step (a) comprises the steps of:
(a-1) receiving the keyboard data including the first to third bytes through an air interface;
(a-2) checking a transmission error on the basis of data of the second and third bytes;
(a-3) determining whether a key is in a make/brake mode on the basis of the make/brake bit contained in the second byte;
(a-4) determining whether the key is a function key on the basis of the special bit contained in the first byte if the key is in the make mode, and setting the special bit to generate a make code if the key is the function key; and
(a-5) determining whether the key is the function key if the key is in the brake mode, and clearing the special bit to generate a brake code if the key is not the function key.

12. The method as set forth in claim 8, wherein the step (b) is carried out by performing a corresponding operation according to the special bit, make/brake code and scan code.

13. The method as set forth in claim 11, wherein the step (a-1) comprises the steps of:
recovering original keyboard data from a received wireless signal;
recognizing each of the first, second and third bytes contained in the recovered keyboard data through the start and stop bits;
determining whether the received wireless signal corresponds to the keyboard data on the basis of the leader contained in the first byte; and
if the received wireless signal corresponds to the keyboard data, receiving the keyboard data including the first to third bytes.

14. The method as set forth in claim 11, wherein the step (a-2) comprises the steps of:
checking the transmission error of each byte using the parity bit within each byte of the received keyboard data;
checking the transmission error by determining whether an inverted bit and code produced by inverting the make/brake bit and scan code contained in the second byte are the same as the inverted make/brake bit and scan code contained in the third byte; and
ignoring the received keyboard data if the transmission error is detected, and performing a next operation if the transmission error is not detected.

15. The method as set forth in claim 11, wherein the step (a-3) comprises the steps of:
determining whether the key is in the make/brake mode;
if the make/brake bit of the second byte has been set, determining that the key is in the make mode; and
if the make/brake bit of the second byte has been cleared, determining that the key is in the brake mode.

16. The method as set forth in claim 11, wherein each of the steps (a-4) and (a-5) comprises the steps of:
if the special bit of the first byte has been set, recognizing the key as a function key; and
if the special bit of the first byte has been cleared, recognizing the key as a general key.

17. A method for transmitting and receiving keyboard data between a computer and a wireless keyboard having a plurality of general keys and a number of function keys, comprising the steps of:
generating a first byte including a start bit, a leader of fixed bits, one special bit indicating state information of a function key, an inverted special bit, a parity bit and a stop bit in response to a key press or press release;
generating a second byte including a start bit, a make/brake bit indicating whether the key has been pressed, the scan code corresponding to the pressed or press-released key, a parity bit and a stop bit in response to the key press or press release;
generating a third byte including a start bit, an inverted make/brake bit, an inverted scan code, a parity bit and a stop bit in response to the key press or press release;
converting the keyboard data of the first to third bytes into a wireless signal, and transmitting the wireless signal;
receiving the keyboard data including the first to third bytes through an air interface;
checking a transmission error on the basis of data of the second and third bytes;
determining whether a key is in a make/brake mode on the basis of the make/brake bit contained in the second byte;
determining whether the key is a function key on the basis of the special bit contained in the first byte if the key is in the make mode, and setting the special bit to generate a make code if the key is the function key;
determining whether the key is the function key if the key is in the brake mode, and clearing the special bit to generate a brake code if the key is not the function key; and
performing a corresponding operation according to the special bit, make/brake code and scan code.
